(19) United States
(12) Patent Application Publication
(10) Pub. No.: US 2020/0193442 A1
(43) Pub. Date: Jun. 18, 2020

(54) METHOD OF GENERATING A PAYMENT/CREDIT INSTRUMENT

(71) Applicant: COMMUNISIS LIMITED, Leeds (GB)

(72) Inventor: Stephen WREN, Leeds (GB)

(21) Appl. No.: 16/349,207

(22) PCT Filed: Dec. 5, 2016
(86) PCT No.: PCT/GB2016/053828

§ 371 Date: May 10, 2019

(30) Foreign Application Priority Data
Nov. 11, 2016 (GB) 1619101.7

(51) Int. Cl. G06Q 20/40; G06Q 20/04; G06Q 20/38; G06F 16/25; H04L 9/32

(52) U.S. Cl. CPC G06Q 20/4016; G06Q 20/042; H04L 9/3239; G06F 16/258; G06Q 20/385

(57) ABSTRACT

A method of generating a payment/credit instrument 10 comprises generating a code 34 based on at least one string of information to be applied to the payment/credit instrument 10, and applying the generated code 34 to the payment/credit instrument 10, wherein generating the code 34 comprises converting the at least one string of information to a higher base and extracting characters to produce a reduced-length code.

This invention relates to fraud prevention measures and in particular, but not limited to, fraud prevention measures relating to cheque fraud.

One way by which fraudsters use cheques to defraud is to alter the personal details on the cheque. The personal details are first included on a cheque by a manufacturer as a MICR code using a laser printing technique. The MICR code line is the series of numbers that appear on the bottom of a cheque. These numbers contain the serial number of the cheque within the book, the banking sort code, the account number and a transaction code. The key pieces of information that identify which UK bank account to withdraw the funds is taken from the sort code and account number from this MICR code line. If a fraudster alters these numbers, they can potentially present a cheque and the cheque would withdraw the funds from another UK account other than the one originally intended. Specifically, a fraudster may scrape away, remove or amend the personal details and add new, fraudulent details relating to a different account. The altered cheque can then be presented as payment and the amount to which it relates is debited from a different account as fraudulently detailed on the cheque.

GB2512450 discloses a method of generating a payment/credit instrument in order to address the above disadvantage. The method takes key elements of the MICR code line, typically the “Serial Number”, “Sort Code” and “Account Number”, apply a complex algorithm to generate a different string of characters that would represent the MICR Code line as it was intended. This unique complex code is printed in two places on each and every cheque. When the cheque is presented to a clearing bank—the bank encodes the same algorithm and validates that the code printed on the cheque is correct, thus proving that the MICR code line has not been tampered with and are the correct details that have been provided by the relevant bank.

In the UK, when an individual writes a cheque, this cheque is typically presented to a bank, and then each working evening, the cheques presented to the banks are transported to a cheque clearing centre where the cheques are validated and approved for payment. In order to speed up the time in which a cheque is cleared, the UK government are proposing to introduce a cheque clearing process, which is already established in the USA, wherein the cheques are imaged at the bank, and a digital image is sent for clearing. Currently the paper of the cheque and the toner of the printed details provide security features in a cheque. As soon as a digital image of the cheque is made, these security features are lost and what remains is a low resolution image of the cheque. It is possible that it may be more difficult to detect when the personal details of a cheque have been altered when this clearing process is used.

It is an object of the present invention to address the fraudulent practices discussed above.

According to the present invention there is provided an apparatus and method as set forth in the appended claims. Other features of the invention will be apparent from the dependent claims, and the description which follows.

According to a first aspect of the invention there is provided a method of generating a payment/credit instrument comprising generating a code based on at least one string of information to be applied to the payment/credit instrument, and applying the generated code to the payment/credit instrument, wherein generating the code comprises converting the at least one string of information to a higher base and extracting characters to produce a reduced length code.

The code may be based on one or more of a bank sort code, a payment/credit instrument serial number and an account number for the payment/credit instrument. The code may be based on all three of the bank sort code, payment/credit instrument serial number and account number for the payment/credit instrument.

The at least one string of information may be one or more of a bank sort code, a payment/credit instrument serial number and an account number for the payment/credit instrument. A first string of information may comprise a bank sort code; a second string of information may comprise a payment/credit instrument serial number, and a third string of information may comprise an account number for the payment/credit instrument.

Generating the code may comprise moving one or more characters from one string of information to another string of information. The movement of the characters may be carried out to achieve a desired length of string of information. The resulting strings of information are preferably no more than seven characters long.

Three strings of information may be used, having lengths of preferably six or seven characters, more preferably one having a length of six characters and two having lengths of seven characters.

Generating the code may comprise applying a random multiplier to the or each string of information.

Converting the at least one string of information to a higher base may comprise converting the at least one string of information to a base 43 number. Converting a seven-character string of information to base 43 may result in a five-character string of information. Converting a six-character string of information into base 43 may result in a four-character string of information.

The base-converted strings of information may be concatenated.

The characters of the at least one string of information may be re-ordered based on a re-ordering algorithm.

An algorithm may be applied to the at least one string of information to generate at least one string of information with a greater number of characters. The algorithm may be a secure hash algorithm. The algorithm may be a SHA-256 algorithm.

Generating the code may comprise realigning the characters of the string of information.

Applying the generated code to the payment/credit instrument may comprise applying the generated code using a printing technique.

According to a second aspect of the invention there is provided a payment/credit instrument incorporating a code based on at least one string of information to be applied to the payment/credit instrument during generation thereof.

The code may be generated using any of the methods described above in relation to the first aspect of the invention.

The payment or credit instrument may be a cheque or credit slip, as typically used in personal and business banking.

For a better understanding of the invention, and to show how embodiments of the same may be carried into effect, reference will now be made, by way of example, to the accompanying diagrammatic drawings, in which:

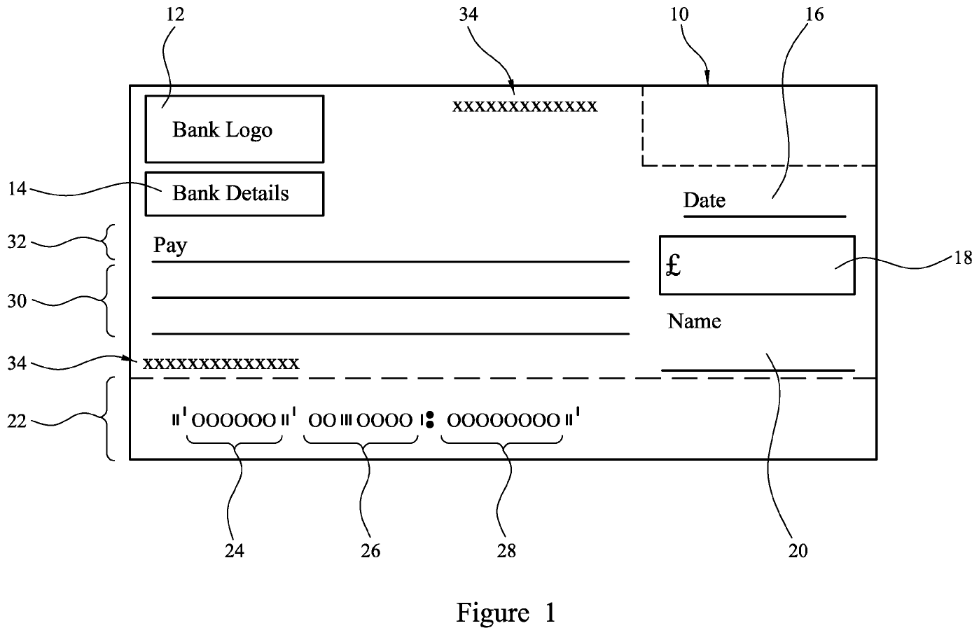

FIG. 1 is a schematic diagram of a cheque.

FIG. 1 shows the layout of a cheque 10. The cheque 10 is printed with information such as a bank logo 12, bank details 14 such as an address of the bank; a date area 16 for a user to enter a date; a signature line 20 for a user to sign the cheque 10. An MICR line 22 is a strip of the cheque 10 at a lower edge thereof that incorporates machine-readable information, such as a cheque serial number 24, a sort code 26 and an account number 28 of the cheque owner's bank account. Two amount lines 30 are provided for a user to write in the amount of a cheque in words; and a pay line 32 is provided fora user to write in a payee of the cheque 10. These elements are present on prior art cheques. The MICR line 22 is located along a lower edge of the cheque 10 and printed in accordance with the standards provided in BS ISO 1004:1995. The MICR line is a machine-readable part of the cheque.

The method of generating the cheque 10 comprises generating a code 34 based on the string of information applied to the cheque during generation thereof and applying the generated code 34 to the cheque 10 in at least one location during generation thereof.

The code 34 is an enhanced Unique Coded Number (eUCN) 34. The steps of generating the eUCN 34 are outlined below. The eUCN 34 is generated by means of an algorithm that links together the sort code 24, account number 28 and serial number 26 on a cheque/credit slip 10. The eUCN 34 is personalised onto the document in order to provide a means to identify instances where the personalised details have been changed. The eUCN 34 will be unique to each individual cheque 10.

The string of information to be converted into the eUCN 34 comprises the serial number 26, the sort code 24 and the account number 28. The sort code 24 comprises six numeric characters, the account number 28 comprises eight numeric characters, and the serial number 26 comprises six numeric characters. The sort code 24, account number 28 and serial number 26 are concatenated into a numeric twenty-character string of information.

The string of information is separated into three elements of six characters, seven characters and seven characters respectively. For example, Sort Code 20-20-20, Account Number 12345678, Serial Number 100000 would become:
202020
1234567
8100000

A random multiplier is generated and applied to each of these elements.

The three elements, with the random multiplier applied, are then converted into a base 43 number. The effect of conversion to base 43 is to render a seven character number into five characters and a six character number into four characters. Base 43 is a positional numeral system using 43 as the radix. The choice of 43 is convenient in that the digits can be represented using selected ASCII Characters. Base 43 is therefore the most compact case-insensitive alphanumeric numeral system using ASCII characters.

These three separate values can then be converted to base 43 using any of the well known conversions. The conversion of the three elements with the random multiplier applied provides three sets of alphanumeric values, one of which will be represented as four characters and the other two of five characters, giving a total of fourteen characters.

For example, conversion of the above three sets of numeric values to base 43, using the character section defined above would be as follows:
4QE9
2IPW#
4I#Z7

The natural string of code would be personalised as such: 4QE92IPW#4I#Z7

An explanation of how this is achieved is provided below, with some introductory explanation first.

Base 10, also known as the decimal system, is the ordinary base used every day. The decimal number system is known as a positional number system, because the value of the number depends on the position of the digits. For example, the number 123 has a very different value than the number 321, although the same digits are used in both numbers.

In a positional number system, the value of each digit is determined by which place it appears in the full number. The lowest place value is the rightmost position, and each successive position to the left has a higher place value.

In the decimal number system, the rightmost position represents the “ones” column, the next position represents the “tens” column, the next position represents “hundreds”, etc. Therefore, the number 123 represents 1 hundred and 2 tens and 3 units, whereas the number 321 represents 3 hundreds and 2 tens and 1 unit.

Base 2 is the binary system where only 2 digits are used to represent a value, 0 and 1. Far more characters are needed to represent the same value in base10. For example to represent 999999 base10 value in base2 (binary system), 20 characters are needed which would be 11110100001000111111.

Going from right to left, this means:

1 times 2\hat{ }0 (1)=1

1 times 2\hat{ }1 (2)=2

1 times 2\hat{ }2 (4)=4

1 times 2\hat{ }3 (8)=8

1 times 2\hat{ }4 (16)=16

1 times 2\hat{ }5 (32)=32

0 times 2\hat{ }6 (64)=0

0 times 2\hat{ }7 (128)=0

0 times 2\hat{ }8 (256)=0

1 times 2\hat{ }9 (512)=512

0 times 2\hat{ }10 (1024)=0

0 times 2\hat{ }11 (2048)=0

0 times 2\hat{ }12 (4096)=0

0 times 2\hat{ }13 (8192)=0

1 times 2\hat{ }14 (16384)=16384

0 times 2\hat{ }15 (32768)=0

1 times 2\hat{ }16 (65536)=65536

1 times 2\hat{ }17 (131072)=131072

1 times 2\hat{ }18 (262144)=262144

1 times 2\hat{ }19 (524288)=524288

If all these calculations are then summed up, the original base10 value is returned: 1+2+4+8+16+32+512+16384+65536+131072+262144+524288=999999

It is desired to reduce the number of characters of the base 10 values of the elements that make up the string of information and therefore the elements are converted to a higher base number, thus a base 43 system is chosen.

The same principle applies to any number base. Base 43 was chosen, so instead of to the power of 10, the power of 43 is used in order to reduce the number of characters that used to represent the base 10 value. As there are only 10 digits (base 10), other non-numeric characters are used to represent a higher base than 10. 43 characters from the ASCII table are used, but for security reasons it is not stated which characters they are.

The three sets of alphanumeric characters generated from the conversion to base 43 are concatenated to generate a fourteen-character code.

The characters of the fourteen-character code are then rearranged into a predefined new order, called the Unique Coded Number (UCN).

As a further security mechanism, a SHA-256 algorithm is applied to the UCN to generate a 64-character code. The SHA-256 algorithm (secure hash algorithm) is a cryptographic hash function with 256 bits. It is a keyless hash function; that is, a manipulation detection code (MDC). A message is processed by blocks of 512=16×32 bits, each block requiring 64 rounds.

The 64-character code is reduced to an eight character code.

The eight characters are then re-aligned to form the eUCN 34. Suspect readable characters are removed. Some characters can be misread, because they appear very similar to other characters in shape, for example I and 1, 0 and O. These characters are remapped to specific, more readable readable characters.

A cheque/credit slip manufacturer laser prints the generated eUCN 34 onto the cheque document 10 to personalise the cheque document 10. The eUCN 34 is laser printed in two separate positions on the cheque 10, in order to reduce the risk of rejections due to the eUCN 34 failing to be read in the clearing process, for example due to a customer writing over it.

The first position of the cheque 10 at which the eUCN 34 is printed is above the MICR code line 22, on the left of the cheque 10, after the production date. The second position is near the top of the cheque 10, between the bank logo 12 and an area called the restraint area, which is located 53 mm from the left hand edge of the cheque 10.

There are a number of different sizes and layouts of cheque types and as such it may be necessary to vary the position of the eUCN 34 depending on the cheque type.

The eUCN 34 applied to the cheque 10 is an Image Survivable (ISV) feature, and so remains visible when a digital image of the cheque is made during the clearing process.

During the clearing process, the eUCN 34 is used to verify that the sort code 24, account number 28 and serial number 26 details on the cheque 10 have not been amended. Cheques 10 are rejected if these details do not match the eUCN 34.

The sort code 24, account number 28, serial number 26 and eUCN 34 are scanned and recorded as part of the cheque 10 scanning process by the processing system. The same algorithm is applied at the clearing bank, which will review the information and return a value of True (a match) or False (a mis-match). Acceptance or rejection will be based on whether an exact match is found or not. If the two codes do not match this indicates the potential fraudulent alteration of some of the details on the cheque 10.

The invention advantageously provides a method of encoding information on a cheque based on and in addition to information already provided on the cheque to enable the cheque to be scrutinised for authenticity. The invention also extends to the provision of cheques with both fraud prevention measures and ISV features added thereto.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of generating a payment/credit instrument comprising generating a code based on at least one string of information to be applied to the payment/credit instrument, and applying the generated code to the payment/credit instrument, wherein generating the code comprises converting the at least one string of information to a higher base, applying a keyless secure hash algorithm to the at least one string of information to generate at least one string of information with a greater number of characters and extracting characters to produce a reduced-length code.

2. The method according to claim 1, wherein the at least one string of information is one or more of a bank sort code, a payment/credit instrument serial number and an account number for the payment/credit instrument.

3. The method according to claim 1, wherein generating the code comprises moving one or more characters from the at least one string of information to another string of information

4. The method according to claim 1, wherein generating the code comprises applying a random multiplier to the at least one string of information.

5. The method according to claim 1, wherein converting the at least one string of information to a higher base comprises converting the at least one string of information to a base 43 number.

6. A payment/credit instrument incorporating a code based on at least one string of information to be applied to the payment/credit instrument during generation thereof, the code being generated by converting the at least one string of information to a higher base and extracting characters to produce a reduced-length code.

7. The payment/credit instrument according to claim 6, wherein the payment/credit information is a cheque or credit slip.

8. The method according to claim 2, wherein generating the code comprises moving one or more characters from the at least one string of information to another string of information

9. The method according to claim 2, wherein generating the code comprises applying a random multiplier to the at least one string of information.

10. The method according to claim 8, wherein generating the code comprises applying a random multiplier to the at least one string of information.

11. The method according to claim 9, wherein converting the at least one string of information to a higher base comprises converting the at least one string of information to a base 43 number.

12. The method according to claim 2, wherein converting the at least one string of information to a higher base comprises converting the at least one string of information to a base 43 number.

13. The method according to claim 8, wherein converting the at least one string of information to a higher base comprises converting the at least one string of information to a base 43 number.

14. The method according to claim 3, wherein generating the code comprises applying a random multiplier to the at least one string of information.

15. The method according to claim 14, wherein converting the at least one string of information to a higher base comprises converting the at least one string of information to a base 43 number.

16. The method according to claim 3, wherein converting the at least one string of information to a higher base comprises converting the at least one string of information to a base 43 number.

17. The method according to claim 4, wherein converting the at least one string of information to a higher base comprises converting the at least one string of information to a base 43 number.

18. A method of generating a payment/credit instrument comprising:
generating a code based on at least one string of information to be applied to the payment/credit instrument, wherein generating the code comprises converting the at least one string of information to a higher base, wherein generating the code comprises moving one or more characters from the at least one string of information to another string of information, wherein generating the code comprises applying a random multiplier to the at least one string of information, wherein converting the at least one string of information to a higher base comprises converting the at least one string of information to a base 43 number;
applying the generated code to the payment/credit instrument; and
applying a keyless secure hash algorithm to the at least one string of information to generate at least one string of information with a greater number of characters and extracting characters to produce a reduced-length code,
wherein the at least one string of information is one or more of a bank sort code, a payment/credit instrument serial number and an account number for the payment/credit instrument.
